(19) United States
(12) Patent Application Publication
(10) Pub. No.: US 2016/0229011 A1
(43) Pub. Date: Aug. 11, 2016

(54) DRILLING AND COUNTERSINKING MACHINE, IN PARTICULAR FOR COMPONENT PARTS OF AIRCRAFT STRUCTURES

(71) Applicant: FIVES MACHINING, Saint-Laurent-les-Tours (FR)

(72) Inventor: Jean-Pierre NICAISE, Saint Jean Lagineste (FR)

(73) Assignee: Fives Machining, Saint Laurent les Tours (FR)

(21) Appl. No.: 15/021,536

(22) PCT Filed: Sep. 11, 2014
(86) PCT No.: PCT/IB2014/064424

§ 371 Date: Mar. 11, 2016

(30) Foreign Application Priority Data
Sep. 12, 2013 (FR) 13 58785

(51) Int. Cl. B23Q 1/00; B23B 45/02

(52) U.S. Cl. CPC B23Q 1/0009; B23B 45/02; B23B 2215/04

(57) ABSTRACT

A drilling and milling machine, in particular for component parts of aircraft structures, comprising electric motors powered by a power unit and controlled by a control unit, said machine being connected to a general power supply; the power unit and the control unit are rigidly connected to the machine and the general power supply is separated from the machine.

### CROSS-REFERENCE TO RELATED APPLICATIONS

This application is the U.S. National Phase of International Patent Application Serial No. PCT/IB2014/064424, filed on Sep. 11, 2014, which claims priority to French Patent Application No. 1358785, filed on Sep. 12, 2013, both of which applications are herein incorporated by reference in their entirety.

### BACKGROUND OF THE INVENTION

(1) Field of the invention

The invention relates to a portable drilling and milling machine notably for parts making up aircraft structures, such as cells, wings, and cabin.

These machines are mainly used by operators as portable machines, but they may be borne and positioned on the structures by robots.

(2) Description of related art

Most drilling machines are equipped with pneumatic motors ensuring rotation of the drilling bit as well as the various movements for advancing the bit. A machine of this type is shown by FR 2 680 329, which provides a pneumatic motor for rotating the spindle, and an electric motor for advance movements requiring less power.

Certain machines are equipped with electric spindle motors with sufficient power, generally greater than 500 watts and which may attain 2000 watts and more. These electric spindle motors, because of their power, are remotely controlled by remote power and control systems. The management of the cycles, of the servo-control parameters, of the links with the sensors or the different actuators, is then remote management in separate boxes of the machine.

These remote systems are bulky and require multiple connections with the machine; these connections may extend over long lengths, of several meters or tens of meters, leading to problems of stability of the signals, both for the power and for the control, and for observance of the regulations for electric safety.

Protection of the operators and of the power supply elements needs to be taken into account.

The object of the invention is especially to provide a performing portable drilling and milling machine, which is of a more practical use.

### BRIEF SUMMARY OF THE INVENTION

A drilling and milling machine notably for parts making up airplane structures, according to the invention, comprises electric motors supplied by a power portion and driven by a control portion, said machine being connected to a general power supply, and is characterized in that the power portion and the control portion are integral with the machine and in that the general power supply is dissociated form the machine.

The power portion ensures the supply to the spindle motor of electric signals of suitable power, established from the current provided by the general power supply. The advance motor is also powered by the power portion.

The control portion integrates the logic for driving the machine for its different operating modes.

The machine may be connected to the general power supply through a fast-disconnecting connector, making the machine easily disconnectable from the general power supply. The machine may be equally connected to various general power supplies.

Preferably, the electric motors of the machine are of the brushless type (no brushes).

Advantageously, the machine is connected to an external power supply casing including a general electric power supply box provided so as to be connected on the electric mains, with alternating current, and for providing at the output a high DC voltage for the power and a low DC voltage for the control, and the power module is able to provide power current signals, notably three-phase signals, from the DC current under a high voltage from the casing.

The machine may be connected to the external power supply casing through a single common connecting cable, integrating an electric connection cable with high DC voltage conductors for the power, and low voltage conductors for the control, as well as a pneumatic connection cable connected on a socket for providing compressed air.

### BRIEF DESCRIPTION OF THE SEVERAL VIEWS OF THE DRAWINGS

The invention except for the arrangements discussed above consists in a certain number of other arrangements which will be discussed more explicitly hereafter concerning exemplary embodiments described with reference to the appended drawings, and which are by no means limiting. In these drawings:

FIG. 1 is a side view of a machine according to the invention with detached portions, connected to the general power supply casing.

FIG. 2 is a perspective three-quarters rear left view of the machine with detached portions, and

FIG. 3 is a side view at a larger scale of the machine with detached portions.

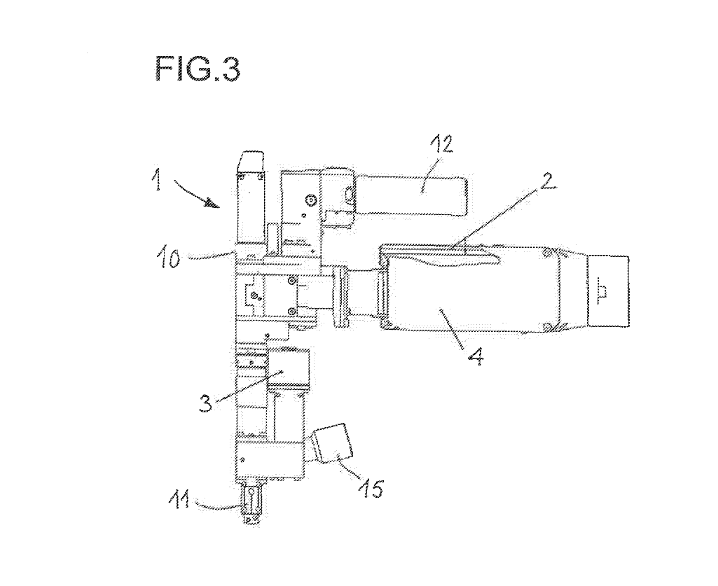

### DETAILED DESCRIPTION OF THE INVENTION

With reference to the drawings, a drilling and milling machine 1 may be seen, according to the invention, which has an architecture for which the power portion and the control portion are entirely integrated to the machine.

This architecture consists of four main elements, two of which are integrated onto the drilling machine 1, and two other ones are remote elements.

Both elements integrated on the drilling machine 1 comprise:
a power module 2, forming the power portion for simultaneously powering two electric motors 3, 4 and an optional additional motor;
a control module 5, forming the control portion, which handles the totality of the machine functions:
   the sequencing of the operation of the machine
   the Man-Machine Interface (starting cycles, parameterization, etc . . . )
   recording data of the process
   a geolocalization device (GPS or RFID Chip)

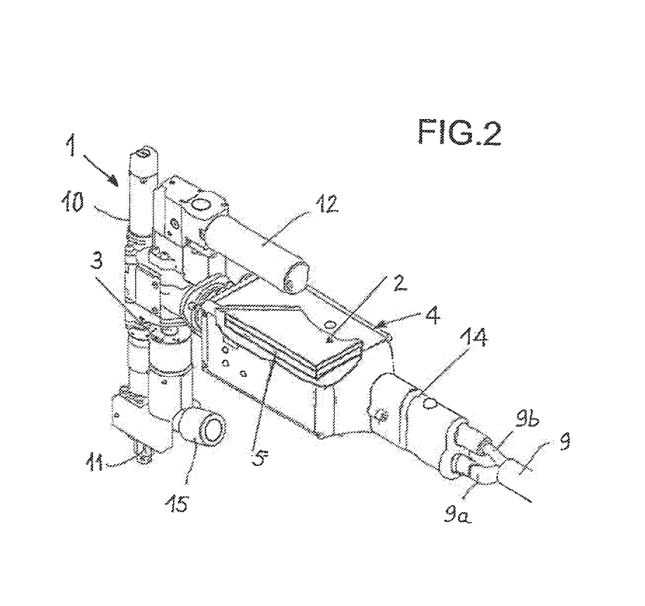

The power 2 and control 5 modules may be localized on a same card or on two distinct electronic cards, as illustrated in FIG. 2.

Two other elements of the architecture are placed remotely out of the machine, on the electric mains 6 of the user, and comprise:
an external power supply casing 7, simple to connect and not very bulky. The casing includes a general electric power supply box 8 provided so as to be connected on the electric mains 6, generally with alternating current under a voltage of 230V AC, and for providing at the output a high DC voltage, notably 350V DC and a low DC voltage, notably 24V DC for the control.
a single common connecting cable 9, integrating an electric connection cable 9a with high DC voltage conductors for the power and low voltage conductors for the control, as well as a pneumatic connection cable 9b connected on a socket 9c for providing dry compressed air, notably under 6.5 bars.

The drilling machine 1 includes a case 10 in which is rotatably mounted a spindle 11 which may be displaced in translation, along the direction of its geometrical axis, according to a movement for advancing or moving back, by the motor 3, positioned with its axis parallel to the spindle, and with a transmission mechanism.

The electric power motor 4 is positioned, according to the illustrated example, at right angles to the case with an angular mechanical transmission for driving the spindle 11 into rotation. A maneuvering handle 12 is positioned above the motor 4.

The motor 4, as well as the motor 3, are advantageously motors of the—brushless—type or without any brushes, operating with notably three-phase power current signals. The power module 2 is able to provide power current signals from high voltage DC current from the box 8.

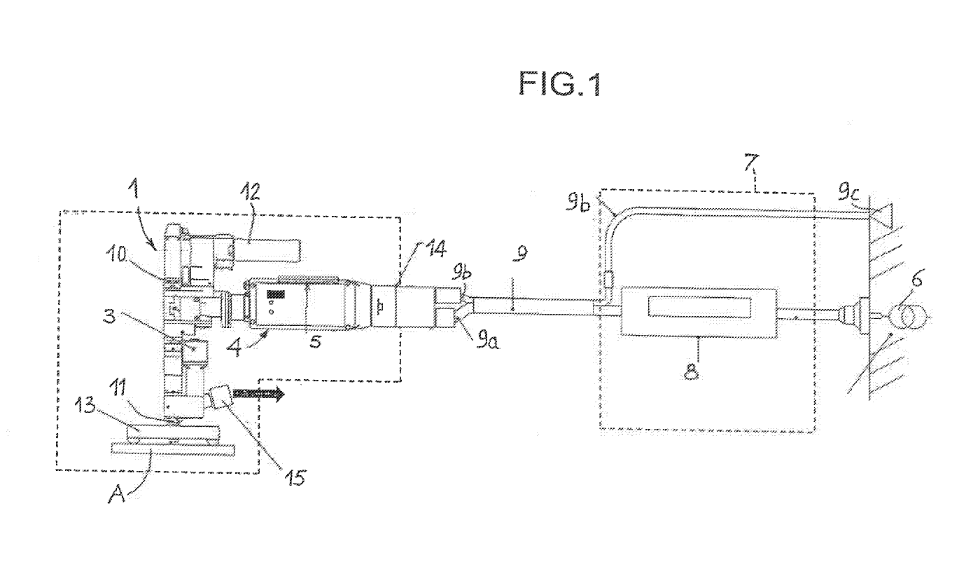

The machine 1 is positioned accurately, on a part A (FIG. 1) to be drilled, by means of a drilling grid 13, forming a template. The grid 13 is positioned and set accurately on the part A. Means, not shown are provided for attachment of the machine 1 on the grid 13, with the spindle 11 properly oriented, notably orthogonal to the surface facing the part A.

A fast disconnectable connector 14 is provided on the machine 1 for connection to the cable 9. Compressed air distribution is ensured in the machine 1, from the pneumatic cable 9b, notably for cooling the motors and/or an auxiliary pneumatic control and/or engagement of a gear box. A nozzle 15 is provided, in the vicinity of the lower end of the spindle provided with a tool, for suction of the savings by being connected to a negative pressure source.

Thus, according to the invention, the drilling and/or milling machine 1, notably for parts making up airplane structures, comprises for driving the spindle, the electric power motor 4 powered by a power portion 2. This power portion, or module 2 is integrated into the machine and ensures provision of power electric signals from a high DC voltage power supply of the order of 350V DC, provided by the remote power supply box 7. The other electric motor 3, of lesser power, ensures the forward and backward movement of the spindle. The electric motors 3 and 4 are driven by the control portion 5 also integrated to the machine. The power portion 4 and the control portion 5 are therefore integral with the machine 1 and the general power supply 7 is dissociated from the machine 1.

The control portion 5 integrates the logic for driving the machine 1 for its different operating modes. The machine 1 is easily disconnectable from the general power supply 7 by means of the fast connector 14.

The machine may be equally connected to various general power supplies 7, in so far that the output characteristics of the power supplies correspond to the input ones of the machine.

The machine according to the invention has many advantages, including the following:
The machine is self-contained and is easily connected to the electric mains and the air network without any particular precautions.
Improvement in the safety of the user and in the stability of the signals by the use of a single cable comprising a number of reduced connections.
All the parameters (processes and cycles) are specific to the machine, loaded and recorded on the latter, in particular on the control module 5, via an USB or RJ45 port.
Traceability of the process data is facilitated by the recording of the data on the control modules 5 of each machine;
   Control of the torque
   Control of the force
   Counters (hole number and date for example)
   Geolocalization of the operations carried out
The use of the machines is facilitated by a man/machine interface integrated to the control module 5 and identical for the various possible machine versions (electromechanical, pneumatic, entirely electric).

1. A drilling and milling machine notably for parts making up airplane structures, comprising electric motors powered by a power portion and driven by a control portion, said machine being connected to a general power supply, wherein the power portion and the control portion are integral with machine, and in that the general power supply is dissociated from the machine.

2. The machine according to claim 1, wherein the control portion integrates the logic for driving the machine for its different operating modes.

3. The machine according to claim 1, further comprising a fast disconnecting connector, making it easily disconnectable from the general power supply.

4. The machine according to claim 1, further being able to be equally connected to various general power supplies.

5. The machine according to claim 1, wherein the electric motors are of the “brushless” type.

6. The machine according to claim 5, further being connected to an external power supply casing including a general electric power supply box provided so as to be connected on the electric mains, with alternating current, and for providing at the output a high DC voltage for the power and a low DC voltage for the control, and the power module is able to provide three-phase power current signals from the DC current under a high voltage from the box.

7. The machine according to claim 6, further being connected to the external power supply casing through a single common connecting cable, integrating an electric connection cable with high DC voltage conductors for the power, and low voltage conductors for the control, as well as a pneumatic connecting cable connected on a socket providing compressed air.
